(19) United States
(12) Patent Application Publication
(10) Pub. No.: US 2025/0106507 A1
(43) Pub. Date: Mar. 27, 2025

(54) CONTROL DEVICE, LEARNED MODEL GENERATOR, MEDICAL ASSISTANT METHOD

(71) Applicant: OLYMPUS MEDICAL SYSTEMS CORP., Tokyo (JP)

(72) Inventor: Daichi WATANABE, Tokyo (JP)

(73) Assignee: OLYMPUS MEDICAL SYSTEMS CORP., Tokyo (JP)

(21) Appl. No.: 18/891,430

(22) Filed: Sep. 20, 2024

Related U.S. Application Data
(60) Provisional application No. 63/540,171, filed on Sep. 25, 2023.

(51) Int. Cl. H04N 23/67; G06T 5/50; G06T 7/50

(52) U.S. Cl. CPC H04N 23/67; G06T 5/50; G06T 7/50; G06T 2207/10068; G06T 2207/20221

(57) ABSTRACT

A control device includes: a processor, the processor being configured to acquire a first, second and third images from an imaging device including an optical system configured to change a focal length, an imaging element configured to expose an image formed by the optical system to generate a still image, and a focus adjustment mechanism configured to move the optical system along an optical axis direction of the optical system to change the focal length, input the first image, the second image, and the third image as input parameters to a learned model configured to output a depth map indicating a distance from the optical system to the subject as an output parameter, to infer a depth map of the subject, and output the depth map of the subject.

### CROSS-REFERENCE TO RELATED APPLICATION

This application is based on and claims priority under 35 U.S.C. § 119 to U.S. Provisional Application No. 63/540, 171, filed Sep. 25, 2023, the entire contents of which are incorporated herein by reference.

### BACKGROUND

### 1. Technical Field

The present disclosure relates to a control device, a learned model generator, a medical assistant method.

### 2. Related Art

In the related art, in an imaging device such as a digital camera, a technique of estimating a distance between a subject and the imaging device from a degree of blurring of a captured image is known. For example, in JP 2020-148483 A, the second image affected by the aberration of the optical system is input to the statistical model generated by learning the blur that varies non-linearly according to the distance to the subject generated in the first image affected by the aberration of the optical system, and the distance information indicating the distance to the subject in the second image is acquired.

In addition, in JP 5868183 B2, a distance between an imaging device and a subject in each image region in a sweep image is calculated based on a blur amount of each image region with respect to an all focus image in the sweep image captured by exposure by an image sensor while continuously moving a focal length of a lens from a near end to a desired end, and an optical coefficient value of the imaging device including the focal length of the lens, and a depth map (distance map) indicating the distance by a pixel value in each image region is generated.

### SUMMARY

In some embodiments, a control device comprises: one or more processors comprising hardware, the one or more processors being configured to: acquire first, second and third images from an imaging device, control the imaging device to generate the first image by an image sensor imaging a subject on a near point side of the optical system, control the imaging device to generate the second image by the image sensor imaging the subject during a period in which a focal length of the optical system is changed and moved between the near point side and a far point side of the optical system by the focus adjustment mechanism, control the imaging device to generate the third image by the image sensor imaging the subject on the far point side of the optical system, input the first, second, and third images as input parameters to a learned model configured to output a depth map indicating a distance from the optical system to the subject as an output parameter, to infer a depth map of the subject, and output the depth map of the subject.

In some embodiments, a learned model generator comprises: one or more processors comprising hardware, the one or more processors being configured to: acquire learning data obtained by combining a plurality of first images, a plurality of second images, a plurality of third images, and a correct value of a depth map with each of a plurality of targets, from an imaging device, control the imaging device to generate the plurality of first images by an image sensor imaging the plurality of targets on a near point side of the optical system, control the imaging device to generate the plurality of second images by the imaging image sensor the plurality of targets during a period in which the focus adjustment mechanism changes and moves a focal length of the optical system between the near point side and a far point side of the optical system, control the imaging device to generate the plurality of third images by the image sensor imaging the plurality of targets on a far point side of the optical system, the correct value of the depth map being related to a distance from the optical system to each of the plurality of targets, and generate, by learning using the learning data, a learned model configured to output a depth map indicating a distance from the optical system to a subject as an output parameter with the first, second, and third images as input parameters.

In some embodiments, a medical assistant method executed by a control device including one or more processors, the medical assistant method comprising: acquiring, by the one or more processors, first, second and third images from an imaging device controlling the imaging device to generate the first image by the image sensor imaging a subject on a near point side of the optical system, controlling the imaging device to generate the second image by the image sensor imaging the subject during a period in which a focal length of the optical system is changed and moved between the near point side and a far point side of the optical system by the focus adjustment mechanism, controlling the imaging device to generate the third image by the image sensor imaging the subject on the far point side of the optical system; inputting, by the processor, the first image, the second image, and the third image as input parameters to a learned model configured to output a depth map indicating a distance from the optical system to the subject as an output parameter, to infer a depth map of the subject; and outputting, by the processor, the depth map of the subject.

The above and other features, advantages and technical and industrial significance of this disclosure will be better understood by reading the following detailed description of embodiments of the disclosure, when considered in connection with the accompanying drawings.

### BRIEF DESCRIPTION OF THE DRAWINGS

FIG. 1 is a block diagram illustrating a functional configuration of a learned model generator according to an embodiment;

FIG. 2 is a diagram schematically illustrating movement of a focus lens in an optical system of the learned model generator according to an embodiment;

FIG. 3 is a diagram illustrating an overall configuration of an endoscope system according to an embodiment;

FIG. 4 is a block diagram illustrating a functional configuration of a main part of an endoscope and a control device according to an embodiment;

FIG. 5 is a flowchart illustrating an outline of processing executed by the learned model generator according to an embodiment;

FIG. 6 is a diagram schematically illustrating a learning data set input to a learning model by a learning unit according to an embodiment;

FIG. 7 is a diagram schematically illustrating association between a depth map and an image;

FIG. 8 is a flowchart illustrating an outline of processing executed by the endoscope system according to an embodiment;

FIG. 9 is a flowchart illustrating an outline of a measurement mode process in FIG. 8;

FIG. 10 is a timing chart illustrating a position on an optical axis of a focus lens included in an endoscope and an exposure timing of an imaging element at the time of a measurement mode process executed by the endoscope system according to an embodiment;

FIG. 11 is a view illustrating an example of a subject imaged by the endoscope;

FIG. 12 is a diagram illustrating an example of image data captured by an endoscope;

FIG. 13 is a diagram illustrating another example of image data captured by the endoscope;

FIG. 14 is a diagram illustrating another example of image data captured by the endoscope;

FIG. 15 is a diagram schematically illustrating an estimation method by which a calculation unit estimates a shape of a subject;

FIG. 16 is a view illustrating an example of an image corresponding to a shape of a subject;

FIG. 17 is a timing chart illustrating a position on an optical axis of a focus lens included in an endoscope and an exposure timing of an imaging element at the time of a measurement mode process executed by the endoscope system according to the first modification of an embodiment; and

FIG. 18 is a timing chart illustrating a position on an optical axis of a focus lens included in an endoscope and an exposure timing of an imaging element at the time of a measurement mode process executed by the endoscope system according to the first modification of an embodiment.

### DETAILED DESCRIPTION

Hereinafter, a learned model generator and an endoscope system according to the present disclosure will be described in detail with reference to the drawings. Note that the present disclosure is not limited to the following exemplary embodiments. In addition, each drawing referred to in the following description merely schematically illustrates a shape, a size, and a positional relationship to an extent that the content of the present disclosure can be understood. That is, the present disclosure is not limited only to the shape, size, and positional relationship illustrated in each drawing. Further, in the description of the drawings, the same parts will be described with the same reference numerals. Furthermore, in the following, the configuration of the endoscope system will be described after describing the configuration of the learned model generator according to the present disclosure.

### Configuration of Learned Model Generator

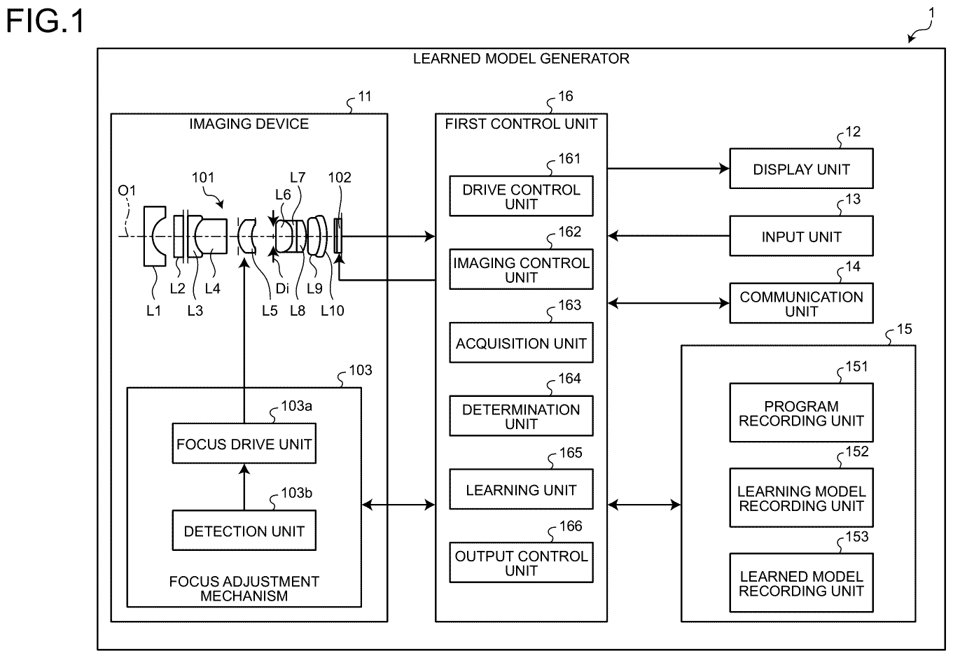

FIG. 1 is a block diagram illustrating a functional configuration of a learned model generator according to an embodiment. A learned model generator 1 illustrated in FIG. 1 is a device that generates a learned model by inputting learning data of a plurality of combinations in which a plurality of images having a different in-focus position (focal points) for each subject and a depth map (correct value) indicating a distance between the subject for each pixel and an optical system are associated with each other to a predetermined learning model.

The learned model generator 1 illustrated in FIG. 1 includes an imaging device 11, a display unit 12, an input unit 13, a communication unit 14, a recording unit 15, and a first control unit 16.

Under the control of the first control unit 16, the imaging device 11 collects and receives light from a predetermined visual field area to generate image data (RAW data) of a subject image to output the image data to the first control unit 16. The imaging device 11 includes an optical system 101, an imaging element 102, and a focus adjustment mechanism 103.

The optical system 101 includes lenses L1 to L10 and a diaphragm Di. The optical system 101 forms a subject image on the light receiving face of the imaging element 102. In addition, the optical system 101 includes a focus lens L5 movable along an optical axis O1 direction among the lenses L1 to L10. The focus lens L5 moves back and forth along the optical axis O1 direction by the focus adjustment mechanism 103 to be described later.

The imaging element 102 generates image data by receiving the subject image formed by the optical system 101. The imaging element 102 includes, for example, an image sensor of a complementary metal oxide semiconductor (CMOS) sensor or a charge coupled device (CCD) sensor.

The focus adjustment mechanism 103 changes an in-focus position (focal point) of the optical system 101 by moving the focus lens L5 of the optical system 101 along the optical axis O1 under the control of the first control unit 16. The focus adjustment mechanism 103 includes a focus drive unit 103a and a detection unit 103b.

The focus drive unit 103a includes, for example, an actuator including a stepping motor, a voice coil motor, or the like, and moves the focus lens L5 to a predetermined position on the optical axis O1 by driving the actuator under the control of the first control unit 16.

The detection unit 103b detects focal length information about the position or the focal length of the focus lens L5 in optical system 101 to output the detection result to the first control unit 16. The detection unit 103b includes, for example, an encoder, a photocoupler, or the like. Note that the detection unit 103b may detect the position of the focus lens L5 on the optical axis O1 based on the drive amount of the focus drive unit 103a.

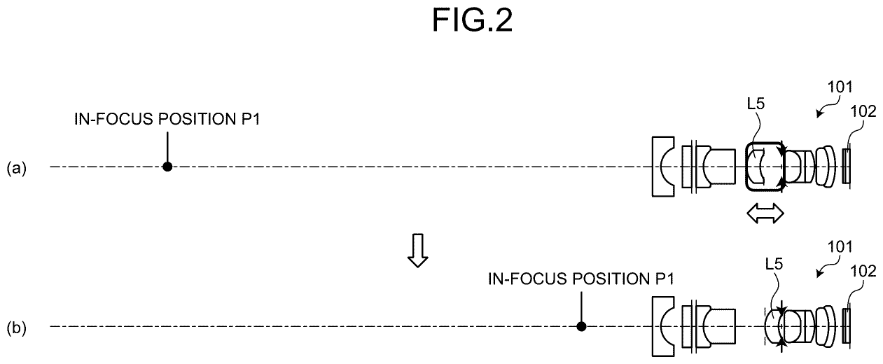

FIG. 2 is a view schematically illustrating movement of the focus lens L5 in optical system 101. As illustrated in (a) and (b) of FIG. 2, the focus drive unit 103a changes an in-focus position P1 (focal point) of the optical system 101 by moving the focus lens L5 to a predetermined position on the optical axis O1 by driving under the control of the first control unit 16 ((a) of FIG. 2→(b) of FIG. 2). Thus, the optical system 101 can change the in-focus position P1 between the far point end and the near point end.

Returning to FIG. 1, the description of the configuration of the learned model generator 1 will be continued.

The display unit 12 displays a display image corresponding to various types of information and image data input from the first control unit 16. The display unit 12 includes an organic electroluminescent display (EL display), a liquid crystal display, or the like.

The input unit 13 receives inputs of various operations by the user to output information corresponding to the received various operations to the first control unit 16. The input unit 13 includes an input interface such as a keyboard, a mouse, or a touch panel.

The communication unit 14 transmits various types of information input from the first control unit 16 to the outside, and outputs various types of information received from the outside to the first control unit 16. The communication unit 14 includes, for example, a communication module or the like in which Wi-Fi (registered trademark) or Bluetooth (registered trademark) is available.

The recording unit 15 records various types of information about the learned model generator 1. The recording unit 15 includes a hard disk drive (HDD), a solid state drive (SSD), a flash memory, a volatile memory, a nonvolatile memory, and the like. The recording unit 15 includes a program recording unit 151, a learning model recording unit 152, and a learned model recording unit 153.

The program recording unit 151 records various programs executed by the learned model generator 1, for example, a program for generating a learned model.

The learning model recording unit 152 records a learning model for the first control unit 16 to be described later to input input parameters.

The learned model recording unit 153 records a plurality of learned models learned using the learning data.

The first control unit 16 is realized by gate array (FPGA), a graphics processing unit (GPU), or a central processing unit (CPU), and a memory that is a temporary storage area used by the processor. The first control unit 16 includes a drive control unit 161, an imaging control unit 162, an acquisition unit 163, a determination unit 164, a learning unit 165, and an output control unit 166.

The drive control unit 161 drives the focus adjustment mechanism 103 to move the focus lens L5 to the near point end of the optical system 101.

The imaging control unit 162 causes the imaging element 102 to capture images at the near point end, during movement from the near point end to the far point end, and at the far point end of the focus lens L5.

The acquisition unit 163 acquires image data generated by the imaging element 102. Specifically, the acquisition unit 163 acquires image data (hereinafter, simply referred to as a “first image”) generated by the imaging element 102 capturing an image at the near point end of the focus lens L5. In addition, the acquisition unit 163 acquires a plurality of pieces of image data (hereinafter, simply “a plurality of second images”) generated by the imaging element 102 capturing a plurality of images during the movement period in which the focus lens L5 moves from the near point end to the far point end. The acquisition unit 163 acquires image data (hereinafter, simply referred to as a “third image”) generated by the imaging element 102 capturing an image at the far point end of the focus lens L5.

The determination unit 164 determines whether the predetermined number of images required for learning has been acquired.

The learning unit 165 performs learning using a predetermined learning model and learning data obtained by combining a plurality of images for each subject acquired by the acquisition unit 163, the plurality of images having different in-focus positions with a depth map. Specifically, the learning unit 165 performs learning by using a learning model generated by machine learning using artificial intelligence (AI). The method of constructing the learning model used by the learning unit 165 is not particularly limited, and various machine learning methods such as deep learning using a neural network, support vector machine, decision tree, simple Bayes, and k-nearest neighbor algorithm can be used. Furthermore, the depth map is information in which the subject distance from the position of an imaging element 203 (position of a distal end portion 24) to the corresponding position on the observation target corresponding to the pixel position in the captured image is detected for each pixel position.

The output control unit 166 outputs the learned model generated by the learning unit 165 to the learned model recording unit 153.

### Schematic Configuration of Endoscope System

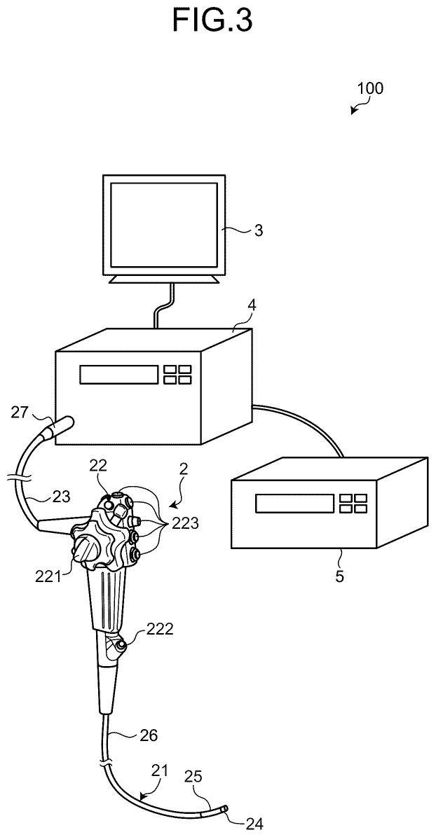

Next, a configuration of an endoscope system 100 will be described. FIG. 3 is a diagram illustrating an overall configuration of the endoscope system 100 according to an embodiment.

The endoscope system 100 illustrated in FIG. 3 continuously images the inside of the subject by inserting an insertion unit 21 of an endoscope 2 from the mouth of the subject such as a person or an animal to the esophagus or from the anus of the subject to the large intestine, and displays the imaged image data group on a display device 3 in chronological order. Furthermore, in the endoscope system 100, an image diagnosis device 5 (Computer Aided Detection: CAD) detects (recognizes or estimates) a characteristic region including an organ, a site, a polyp, a cancer, and the like of a plurality of observed regions and treatment on a living body by a treatment tool such as forceps or a snare appearing in image data based on an image data group input from a control device 4 and an inference model (learned model) learned using learning data obtained by imaging an organ, a site, a lesion, and the like of a subject in advance to output detection result information to the control device 4. An operator such as a doctor observes and treats the subject while confirming the display image displayed on a display device 3 and the detection result (estimation result) by an image diagnosis device 5.

As illustrated in FIG. 3, the endoscope system 100 includes the endoscope 2, the display device 3, the control device 4, and the image diagnosis device 5.

The endoscope 2 continuously generates image data (RAW data) by imaging the inside of the subject, and sequentially outputs the image data to the control device 4. As illustrated in FIG. 1, the endoscope 2 includes the insertion unit 21, an operating unit 22, and a universal cord 23.

At least part of the insertion unit 21 has flexibility and is inserted into the subject. As illustrated in FIG. 1, the insertion unit 21 includes the distal end portion 24 provided at a distal end of the insertion unit 21, a bending portion 25 connected to a proximal end side (operating unit 22 side) of the distal end portion 24 and configured to be bendable, and an elongated flexible tube portion 26 connected to a proximal end side of the bending portion 25 and having flexibility.

The operating unit 22 is connected to a proximal end portion of the insertion unit 21. Then, the operating unit 22 receives various operations of the endoscope 2. As illustrated in FIG. 1, the operating unit 22 is provided with a bending knob 221, an insertion port 222, and a plurality of operation members 223.

The bending knob 221 is configured to be rotatable according to a user operation by a user such as an operator. The bending knob 221 turns to operate a bending mechanism (not illustrated) such as a metal or resin wire disposed in the insertion unit 21. As a result, the bending portion 25 bends.

The insertion port 222 communicates with a treatment tool channel (not illustrated) which is a conduit extending from the distal end of the insertion unit 21, and is an insertion port for inserting a treatment tool or the like into the treatment tool channel from the outside of the endoscope 2.

The plurality of operation members 223 includes buttons and the like that receive various operations by a user such as an operator, and outputs operation signals corresponding to the various operations to the control device 4 via the universal cord 23. Examples of the various operations include a release operation for instructing the endoscope 2 to capture a still image, an operation for switching the observation mode of the endoscope 2 to the normal light observation mode or the special observation mode, and the like.

The universal cord 23 is a cord extending from the operating unit 22 in a direction different from the extending direction of the insertion unit 21 and provided with a light guide 231 (see FIG. 2) including an optical fiber or the like, a first signal line 232 (see FIG. 2) for transmitting the image data described above, a second signal line 233 (see FIG. 2) for transmitting the operation signal described above, and the like. As illustrated in FIG. 1, a first connector portion 27 is provided at the proximal end of the universal cord 23. The first connector portion 27 is detachably connected to the control device 4.

The display device 3 includes a display monitor such as liquid crystal or organic EL, and displays a display image based on image data on which the image process has been performed by the control device 4 and various types of information about the endoscope 2 under the control of the control device 4.

The control device 4 is realized by including a processor that is a processing device having hardware such as a GPU, an FPGA, or a CPU, and a memory that is a temporary storage area used by the processor. The control device 4 integrally controls operation of each unit of the endoscope 2 according to a program recorded in the memory.

The image diagnosis device 5 (CAD) detects (estimates) an organ and a site appearing in the image data, an insertion speed of the insertion unit 21, a characteristic region (abnormal region or lesion candidate region) including a polyp, a cancer, or the like, and treatment of a living body by a treatment tool such as forceps or a snare using the image data group input from the control device 4 and a learned model learned in advance by the learning data to output detection result information in which the detection result and the detection time are associated with each other to the control device 4. The image diagnosis device 5 is realized by including a processor that is a processing device having hardware such as a GPU, an FPGA, or a CPU, and a memory that is a temporary storage area used by the processor.

### Functional Configuration of Main Part of Medical Assistant System

Next, a functional configuration of a main part of the above-described endoscope system 100 will be described.

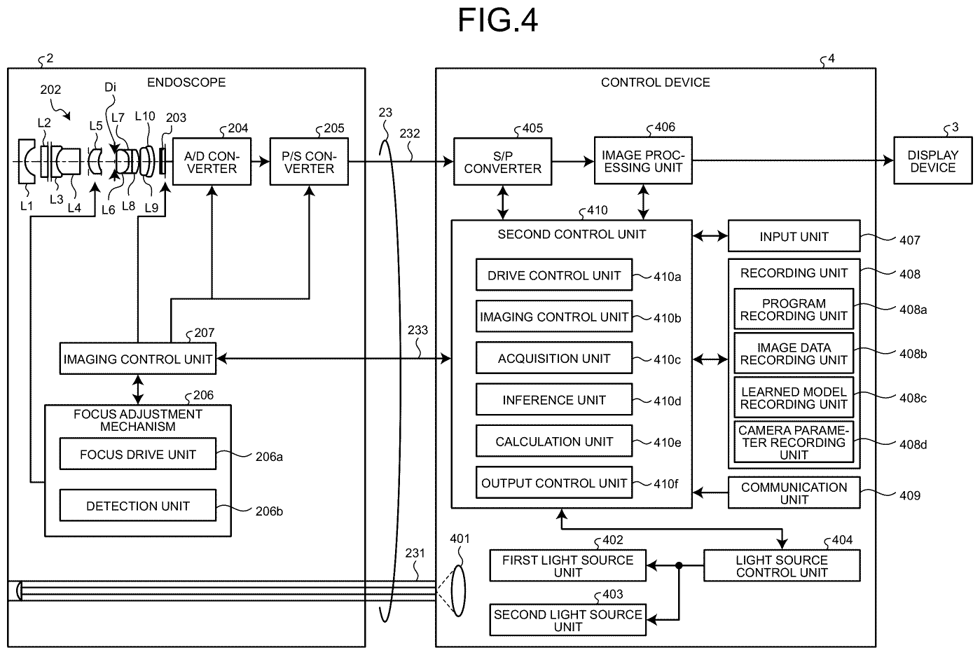

FIG. 4 is a block diagram illustrating functional configurations of main parts of the endoscope 2 and the control device 4. Hereinafter, the endoscope 2 and the control device 4 will be described in this order.

### Functional Configuration of Endoscope

First, a configuration of the endoscope 2 will be described.

As illustrated in FIG. 4, the endoscope 2 includes an illumination optical system 201, an optical system 202, an imaging element 203, an A/D converter 204, a P/S converter 205, a focus adjustment mechanism 206, and an imaging control unit 207. Here, each of the illumination optical system 201, the optical system 202, the imaging element 203, the A/D converter 204, the P/S converter 205, the focus adjustment mechanism 206, and the imaging control unit 207 is disposed in the distal end portion 24.

The illumination optical system 201 includes one or a plurality of lenses and the like, and irradiates the subject with the illumination light supplied from a light guide 231.

The optical system 202 includes lenses L1 to L10 and the diaphragm Di. The optical system 202 forms a subject image on the light receiving face of the imaging element 203. In addition, the optical system 202 includes the focus lens L5 movable along the optical axis O1 direction among the lenses L1 to L10. The focus lens L5 is moved back and forth along the optical axis O1 direction by the focus adjustment mechanism 206. In an embodiment, the optical system 202 can switch between an in-focus position suitable for observation of a medium and distant view and an in-focus position suitable for near point observation. Of course, the optical system 202 does not need to discretely switch the in-focus position by binary, and may be capable of continuously changing to a plurality of desired positions.

The imaging element 203 includes (image sensor of) a CCD or a CMOS in which any one of color filters constituting a Bayer array (RGGB) is disposed in each of a plurality of pixels disposed in a two-dimensional matrix. The imaging element 203 receives the subject image formed by the optical system 202 and performs photoelectric conversion to generate a captured image (analog signal) under the control of the imaging control unit 207. Note that, in an embodiment, the imaging element 203 may be configured such that an image sensor and a TOF sensor that acquires a depth map (subject distance information) by a Time Of Flight (TOF) method are integrated. Note that the configuration for generating the depth map is not limited to the above-described TOF sensor, and an image sensor or the like including a phase difference sensor may be used. Hereinafter, the depth map and the captured image are collectively referred to as image data. The imaging element 203 outputs the image data to the A/D converter 204.

The A/D converter 204 includes an A/D conversion circuit and the like. Under the control of the imaging control unit 207, the A/D converter 204 performs an A/D conversion process on analog image data input from the imaging element 203 to output the converted image data to the P/S converter 205.

The P/S converter 205 includes a P/S conversion circuit and the like, performs parallel/serial conversion of digital image data input from the A/D converter 204 under the control of the imaging control unit 207 to output the converted digital image data to the control device 4 via a first signal line 232.

Note that an E/O converter that converts image data into an optical signal may be provided instead of the P/S converter 205, and the image data may be output to the control device 4 by the optical signal. In addition, image data may be transmitted to the control device 4 by wireless communication such as Wireless Fidelity (Wi-Fi) (registered trademark).

The focus adjustment mechanism 206 changes a focal point (in-focus position) of the optical system 101 by moving the focus lens L5 of the optical system 101 along the optical axis O1 under the control of a second control unit 410 or the imaging control unit 207. The focus adjustment mechanism 206 includes a focus drive unit 206a and a detection unit 206b.

The focus drive unit 206a includes, for example, an actuator including a stepping motor, a voice coil motor, or the like, and moves the focus lens L5 to a predetermined position on the optical axis O1 by driving under the control of the second control unit 410 or the imaging control unit 207.

The detection unit 206b detects focal length information about the position or the focal length of the focus lens L5 in the optical system 202 to output the detection result to the second control unit 410. The detection unit 206b includes, for example, an encoder, a photocoupler, or the like. Note that the detection unit 206b may detect the position of the focus lens L5 on the optical axis O1 based on the drive amount of the focus drive unit 206a.

The imaging control unit 207 is realized by including a timing generator (TG), a processor which is a processing device having hardware such as a CPU, and a memory which is a temporary storage area used by the processor. The imaging control unit 207 controls the operation of each of the imaging element 203, the A/D converter 204, and the P/S converter 205 based on the setting data received from the control device 4 via the second signal line 233.

### Configuration of Control Device

Next, a configuration of the control device 4 will be described.

As illustrated in FIG. 4, the control device 4 includes a condenser lens 401, a first light source unit 402, a second light source unit 403, a light source control unit 404, an S/P converter 405, an image processing unit 406, an input unit 407, a recording unit 408, a communication unit 409, and the second control unit 410.

The condenser lens 401 condenses the light emitted by each of the first light source unit 402 and the second light source unit 403 and emits the light to the light guide 231.

Under the control of the light source control unit 404, the first light source unit 402 emits white light (normal light) that is visible light to supply the white light to the light guide 231 as illumination light. The first light source unit 402 includes a collimator lens, a white light emitting diode (LED) lamp, a drive driver, and the like. The first light source unit 402 may supply white light of visible light by simultaneously emitting light using a red LED lamp, a green LED lamp, and a blue LED lamp. The first light source unit 402 may include a halogen lamp, a xenon lamp, or the like.

The second light source unit 403 emits special light having a predetermined wavelength band under the control of the light source control unit 404 to supply the special light to the light guide 231 as illumination light. Here, the special light is light used for narrowband light observation (Narrow band Imaging: NBI) with narrow-band light including 390 to 445 nm and 530 to 550 nm. Of course, in addition to the narrow-band light, amber light (600 nm and 630 nm) used for red light observation (Red dichromatic Imaging: RDI) may be used as the special light.

The light source control unit 404 is realized by including a processor having hardware such as an FPGA or a CPU and a memory which is a temporary storage area used by the processor. The light source control unit 404 controls light emission timing, light emission time, and the like of each of the first light source unit 402 and the second light source unit 403 based on control data input from the second control unit 410.

Under the control of the second control unit 410, the S/P converter 405 performs serial/parallel conversion on the image data received from the endoscope 2 via the first signal line 232 to output the converted image data to the image processing unit 406. When the endoscope 2 outputs image data in an optical signal, an O/E converter that converts the optical signal into an electric signal may be provided instead of the S/P converter 405. In addition, when the endoscope 2 transmits image data by wireless communication, a communication module capable of receiving a wireless signal may be provided instead of the S/P converter 405.

The image processing unit 406 is realized by including a processor having hardware such as a GPU or an FPGA and a memory which is a temporary storage area used by the processor. Under the control of the second control unit 410, the image processing unit 406 performs predetermined image process on the image data of the parallel data input from the S/P converter 405 to output the converted image data to the display device 3. Here, examples of the predetermined image process include demosaic processing, white balance processing, gain adjustment processing, γ correction processing, format conversion processing, and the like.

The input unit 407 includes a mouse, a foot switch, a keyboard, a button, a switch, a touch panel, and the like, receives a user operation by a user such as an operator, and outputs an operation signal according to the user operation to the second control unit 410.

The recording unit 408 includes a recording medium such as a volatile memory, a nonvolatile memory, a solid state drive (SSD), a hard disk drive (HDD), or a memory card. Then, the recording unit 408 records data including various parameters and the like necessary for the operation of the control device 4 and the endoscope 2. Furthermore, the recording unit 408 includes a program recording unit 408a that records various programs for operating the endoscope 2 and the control device 4, an image data recording unit 408b that records an image file that stores an image corresponding to image data, a learned model recording unit 408c that records a learned model, and a camera parameter recording unit 408d.

Under the control of the second control unit 410, the image data recording unit 408b records an image (endoscope image) corresponding to an image data group and still image data generated by the endoscope 2 continuously imaging a plurality of observed regions of the subject in association with patient information and the like. Here, the still image data is image data captured by the imaging element 203 when an instruction on imaging is given by the release signal input from the operating unit 22, the image data having a higher resolution than the live view image sequentially generated by the imaging element 203.

The learned model recording unit 408c records a learned model that uses a plurality of images having different in-focus positions as input parameters to output a depth map indicating the distance from the optical system 202 to the subject as an output parameter.

The camera parameter recording unit 408d records the camera parameters of the optical system 202. Specifically, the camera parameter is a transform coefficient that associates an image plane (a position of a pixel of the imaging element 203) with an object (a position of a subject). For example, the transformation matrix is a transformation matrix that can be acquired by performing camera calibration using a checkered flat plate. Furthermore, the camera parameter recording unit 408d may record a value of a point (x, y) on the image according to a depth z for each pixel of the imaging element 203 as a look-up table. In this case, the second control unit 410 to be described later may derive the point (x, y) on the image according to the estimated depth z. Furthermore, the camera parameter recording unit 408d may record an approximate expression of the point (x, y) on the image according to the depth z for each pixel of the imaging element 203. In this case, the second control unit 410 to be described later may derive the point (x, y) on the image according to the estimated depth z.

Under the control of the second control unit 410, the communication unit 409 transmits various types of information to the image diagnosis device 5 or the learned model generator 1, receives various types of information from the image diagnosis device 5 or the learned model generator 1, and outputs the information to the second control unit 410. Specifically, under the control of the second control unit 410, the communication unit 409 transmits a temporally continuous image data group on which the image processing unit 406 has performed an image process to the image diagnosis device 5, receives a detection result including an organ, a site, a characteristic region, and the like detected by the image diagnosis device 5 and outputs the detection result to the second control unit 410. Under the control of the second control unit 410, the communication unit 409 receives the learned model received from the learned model generator 1 to output the learned model to the learned model recording unit 408c. The communication unit 409 includes a communication module and the like.

The second control unit 410 corresponds to a second processor according to the present disclosure. The second control unit 410 is realized by including a second processor which is a processing device having hardware such as an FPGA or a CPU, and a memory which is a temporary storage area used by the second processor. Then, the second control unit 410 integrally controls each unit constituting the endoscope 2 and the control device 4. The second control unit 410 includes a drive control unit 410a, an imaging control unit 410b, an acquisition unit 410c, an inference unit 410d, a calculation unit 410e, and an output control unit 410f.

The drive control unit 410a drives the focus adjustment mechanism 206 to move the focus lens L5 to the near point side or the far point end.

The imaging control unit 410b causes the imaging element 203 to expose and capture the subject image condensed by the focus lens L5 at the near point end or the far point end. Furthermore, the imaging control unit 410b causes the imaging element 203 to expose and capture the subject image condensed during the movement period in which the focus lens L5 moves from the near point end to the far point end.

The acquisition unit 410c acquires the first image generated by imaging the subject by the imaging element 203 on the near point side of the focus lens L5. In addition, the acquisition unit 410c acquires one or more of the plurality of second images generated by imaging the subject by the imaging element 203 during a period in which the focus lens L5 is moved by changing the focal length between the near point side and the far point side of the focus lens L5 by the focus adjustment mechanism 206. In addition, the acquisition unit 410c acquires a third image generated by imaging the subject by the imaging element 203 on the far point side of the focus lens L5.

The inference unit 410d estimates the depth map of the subject using the first image, the second image, and the third image acquired by the acquisition unit 410c and the learned model recorded by the learned model recording unit 408c.

The calculation unit 410e estimates the shape of the subject based on the depth map of the subject estimated by the inference unit 410d and the camera parameters of the optical system 202 recorded by the camera parameter recording unit 408d.

The output control unit 410f outputs the shape of the subject estimated by the calculation unit 410e to the display device 3.

### Process by Learned Model Generator

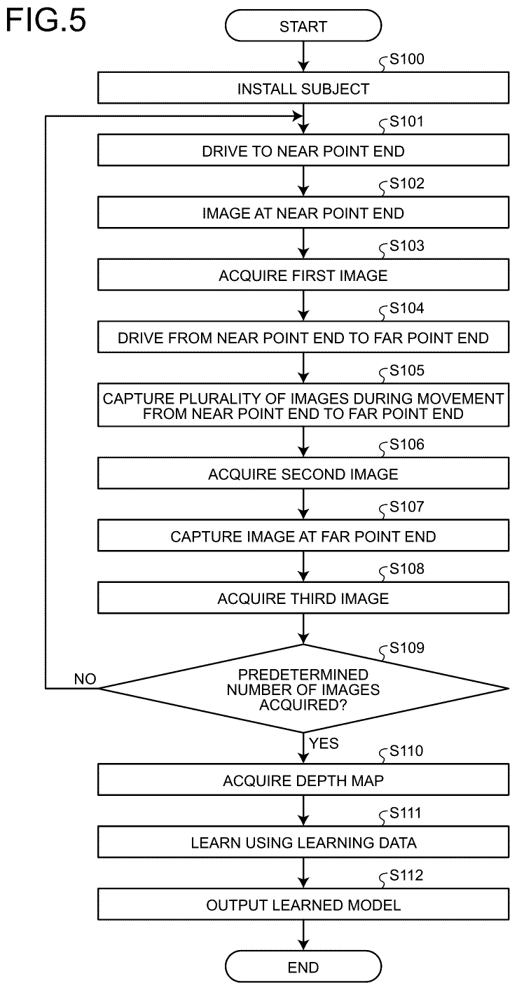

Next, processing executed by the learned model generator 1 will be described. FIG. 5 is a flowchart illustrating an outline of processing executed by the learned model generator 1. Here, the subject distance is a distance from the distal end of the optical system 101 to a subject K1. Furthermore, in the following description, the subject will be described as a planar subject having no unevenness facing the optical system 101. The distance range of the planar subject to be learned is wider than the near point end and the far point end at the in-focus position. For example, when the near point end is 4 mm and the far point end is 20 mm of the in-focus position, the distance of the subject to be learned is 2 mm to 40 mm. As a result, it is possible to estimate the depth for the subject positioned at a point closer or a point farther than the in-focus position.

As illustrated in FIG. 5, first, the learned model generator 1 sets a subject (Step S100). Specifically, the learned model generator 1 sets the subject based on the operation information input by the user via the input unit 13. In this case, in the case of the liquid crystal monitor, the user inputs the type content of the picture and the distance between the liquid crystal monitor and the learned model generator 1 using the input unit 13.

Thereafter, the drive control unit 161 drives the focus adjustment mechanism 103 to move the focus lens L5 to the near point end of the optical system 101 (Step S101).

Subsequently, the imaging control unit 162 causes the imaging element 102 to capture an image at the near point end of the focus lens L5 (Step S102).

Thereafter, the acquisition unit 163 acquires the first image captured and generated by the imaging element 102 at the near point end of the focus lens L5 (Step S103).

Subsequently, the drive control unit 161 drives the focus adjustment mechanism 103 to move the focus lens L5 from the near point end to the far point end (Step S104).

Thereafter, the imaging control unit 162 causes the imaging element 102 to capture a plurality of images during the movement period in which the focus lens L5 moves from the near point end to the far point end (Step S105).

Subsequently, the acquisition unit 163 acquires a plurality of second images generated by the imaging element 102 capturing a plurality of images during the movement period in which the focus lens L5 moves from the near point end to the far point end (Step S106). Note that the acquisition unit 163 acquires all of the plurality of second images generated by the imaging element 102 capturing a plurality of images during the movement period in which the focus lens L5 moves from the near point end to the far point end. However, the disclosure is not limited thereto, and it is sufficient that the acquisition unit may acquire one or more images during the movement period in which the focus lens L5 moves from the near point end to the far point end.

Thereafter, the imaging control unit 162 causes the imaging element 102 to capture an image at the far point end of the focus lens L5 (Step S107).

Subsequently, the acquisition unit 163 acquires a third image captured and generated by the imaging element 102 at the far point end of the focus lens L5 (Step S108).

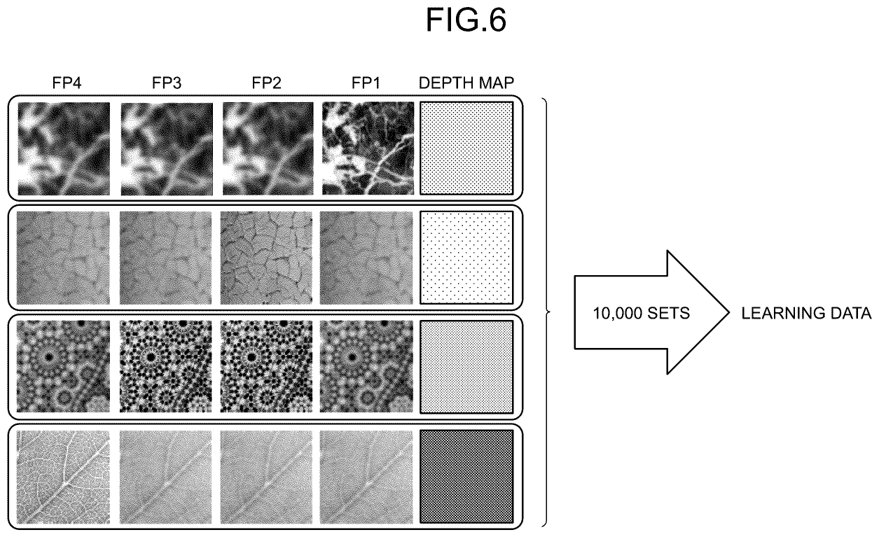

Thereafter, the determination unit 164 determines whether the predetermined number of images required for learning has been acquired (Step S109). Specifically, as illustrated in FIGS. 6 to 9, the determination unit 164 determines, for each of a plurality of subjects, whether the number of a plurality of images captured generated, and acquired at a plurality of in-focus positions exceeds a predetermined number of images (for example, 10,000 images). When the determination unit 164 determines that the predetermined number of images necessary for learning has been acquired (Step S109: Yes), the learned model generator 1 proceeds the process to Step S110 described later. On the other hand, when the determination unit 164 determines that the predetermined number of images required for learning has not been acquired (Step S109: No), the learned model generator 1 returns the process to Step S101.

In Step S110, the acquisition unit 163 acquires the depth map for each subject from the external device or the recording unit 15 via the communication unit 14. The depth map (depth distribution) is obtained by adding a correct value of the distance from the optical system 101 to the subject for each pixel of each subject image. Of course, the acquisition unit 163 may acquire the depth map input by the user via the input unit 13.

Subsequently, the learning unit 165 performs learning using a predetermined learning model and learning data obtained by combining a plurality of images for each subject acquired by the acquisition unit 163, the plurality of images having different in-focus positions, with the depth map (Step S111). Specifically, the learning unit 165 performs learning by using a learning model generated by machine learning using artificial intelligence (AI). The method of constructing the learning model used by the learning unit 165 is not particularly limited, and various machine learning methods such as deep learning using a neural network, support vector machine, decision tree, simple Bayes, and k-nearest neighbor algorithm can be used.

FIG. 6 is a diagram schematically illustrating a learning data set input to the learning model by the learning unit 165. As illustrated in FIG. 6, the learning unit 165 generates a learned model by performing learning using a predetermined learning model and learning data obtained by combining a plurality of images FP1 to FP4 for each subject acquired by the acquisition unit 163, the plurality of images FP1 to FP4 having different in-focus positions, with a depth map. That is, the learning unit 165 generates a learned model that uses the first image, the second image, and the third image as input parameters to output distance information between the subject and the optical system 101 as an output parameter.

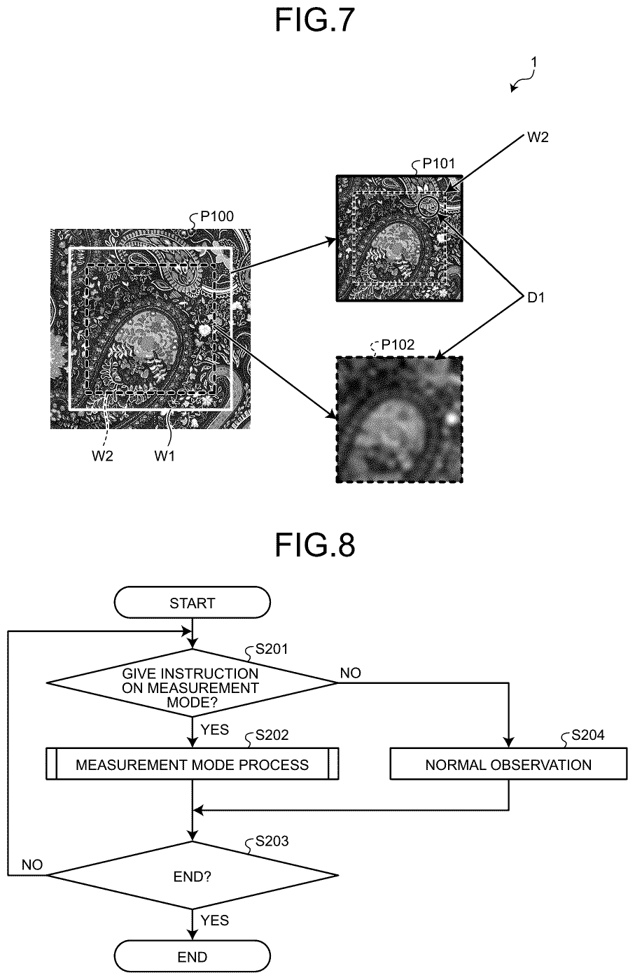

Note that, in an embodiment, the association between the depth map and the image may be performed using at least one of the first image at the near point end and the second image at the far point end among the plurality of images. FIG. 7 is a diagram schematically illustrating association between a depth map and an image. In FIG. 7, a first image P100, a third image P101, and a second image P102 having different in-focus positions (focal points) of the optical system 101 will be described. Further, in FIG. 7, a frame W1 of the first image P100 is an angle of view corresponding to the third image P101, and a frame W2 is an angle of view corresponding to the second image P102. Furthermore, a region D1 is a region in which the depth map can be estimated.

As illustrated in FIG. 7, in an embodiment, since each of the first image P100 and the third image P101 includes a predetermined feature, for example, a characteristic picture, association can be performed between images of the first image P100 and the third image P101, so that association of a depth map to another image, for example, the second image P102 can be performed. Therefore, in an embodiment, when the depth map is associated, it is desirable to associate the depth map with an image having a wide angle of view, for example, the first image P100.

Returning to FIG. 5, the description after Step S112 is continued.

In Step S102, the output control unit 166 outputs the learned model generated by the learning unit 165 to the learned model recording unit 153 (Step S112). In this case, the output control unit 166 may output the learned model to an external device, for example, an endoscope system 100 to be described later, via the communication unit 14. After Step S111, the learned model generator 1 ends this process.

### Process Executed by Medical Assistant System

Next, processing executed by the endoscope system 100 will be described. FIG. 8 is a flowchart illustrating an outline of processing executed by the endoscope system 100.

As illustrated in FIG. 8, the second control unit 410 determines whether an instruction signal for giving an instruction on the observation mode of the endoscope 2 to the measurement mode for measuring the shape of the subject has been input from the operating unit 22 of the endoscope 2 (Step S201). When the second control unit 410 determines that the instruction signal for giving the instruction on the observation mode of the endoscope 2 to the measurement mode for measuring the shape of the subject is input from the operating unit 22 of the endoscope 2 (Step S201: Yes), the endoscope system 100 proceeds the process to Step S202 described later. On the other hand, when the second control unit 410 determines that the instruction signal for giving the instruction on the observation mode of the endoscope 2 to the measurement mode for measuring the shape of the subject is not input from the operating unit 22 of the endoscope 2 (Step S201: No), the endoscope system 100 proceeds the process to Step S204 described later.

In Step S202, the endoscope system 100 executes a measurement mode process of measuring the shape of a predetermined subject in the subject. Note that details of the measurement mode process will be described later.

Subsequently, the second control unit 410 determines whether an instruction signal for ending observation by the endoscope 2 has been input from the operating unit 22 of the endoscope 2 (Step S203). When the second control unit 410 determines that the instruction signal for ending the observation by the endoscope 2 is input from the operating unit 22 of the endoscope 2 (Step S203: Yes), the endoscope system 100 ends this process. On the other hand, when the second control unit 410 determines that the instruction signal for ending the observation by the endoscope 2 is not input from the operating unit 22 of the endoscope 2 (Step S203: No), the endoscope system 100 returns the process to Step S201 described above.

In Step S204, the endoscope system 100 performs normal observation on the subject. Specifically, the second control unit 410 controls the light source control unit 404 to cause the first light source unit 402 or the second light source unit 403 to emit light and cause the imaging element 203 to image reflected light from the subject to generate image data. Then, the second control unit 410 performs normal observation on the subject by causing the image processing unit 406 to perform an image process on the image data generated by the imaging element 203 and causing the display device 3 to display the processed image data. After Step S204, the endoscope system 100 proceeds the process to Step S203.

### Outline of Measurement Mode Process

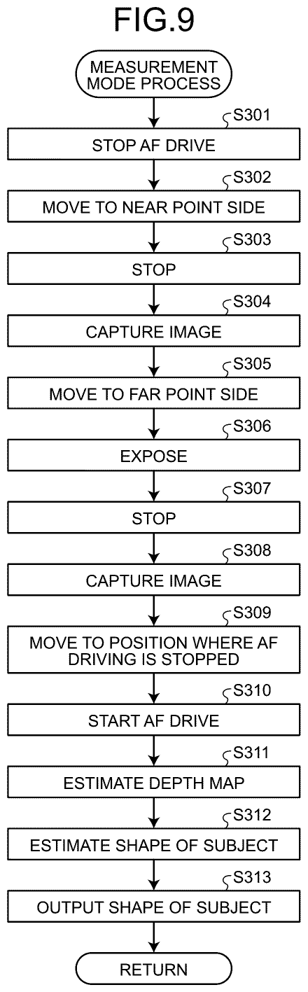

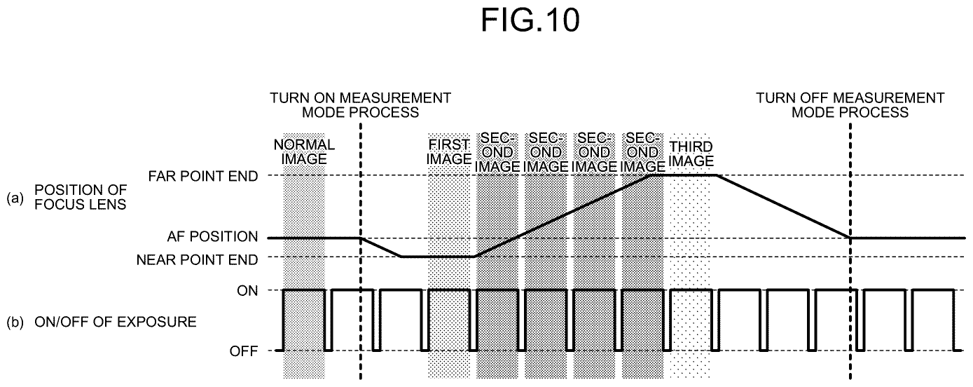

Next, details of the measurement mode process described in Step S202 of FIG. 8 will be described. FIG. 9 is a flowchart illustrating an outline of the measurement mode process. FIG. 10 is a timing chart illustrating the position of the focus lens L5 included in the endoscope 2 on the optical axis O1 and the exposure timing of the imaging element 203 during the measurement mode process. Note that, in FIG. 10, (a) of FIG. 10 illustrates the position of the focus lens L5, and (b) of FIG. 10 illustrates the exposure timing of the imaging element 203.

As illustrated in FIG. 10, first, the drive control unit 410a controls the focus adjustment mechanism 206 to stop AF driving by the focus adjustment mechanism 206 (Step S301).

Subsequently, the drive control unit 410a drives the focus adjustment mechanism 206 to move the focus lens L5 to the near point side (Step S302), and stops the focus lens L5 at the near point end (Step S303). Specifically, as illustrated in (a) of FIG. 10, the drive control unit 410a drives the focus adjustment mechanism 206 to move the focus lens L5 to the near point side, and stops the focus lens L5 at the near point end.

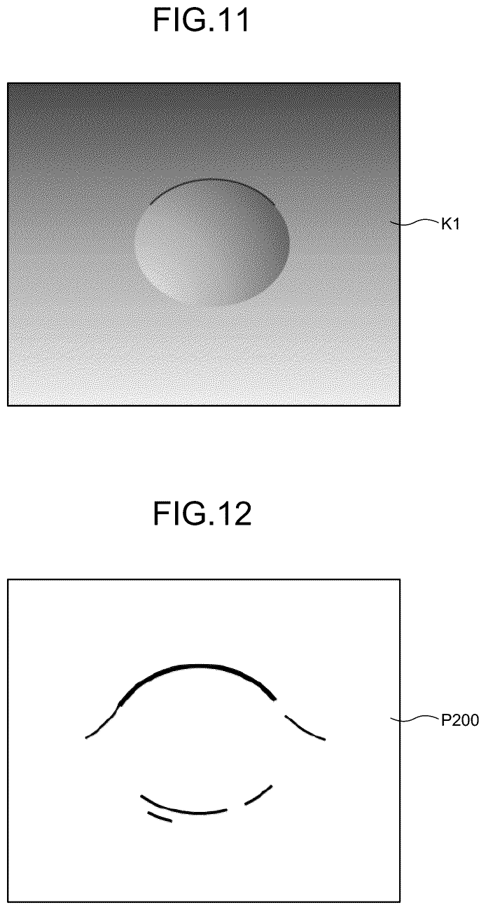

Thereafter, the imaging control unit 410b causes the imaging element 203 to expose and capture the subject image condensed by the focus lens L5 at the near point end (Step S304). Specifically, as illustrated in FIGS. 10 and 11, the imaging control unit 410b causes the imaging element 203 to expose and capture the subject image of the subject K1 condensed by the focus lens L5 at the near point end. In this case, as illustrated in FIG. 12, the acquisition unit 410c acquires the image data generated by the imaging element 203 as a first image P200.

Subsequently, the drive control unit 410a drives the focus adjustment mechanism 206 to move the focus lens L5 to the far point side (Step S305).

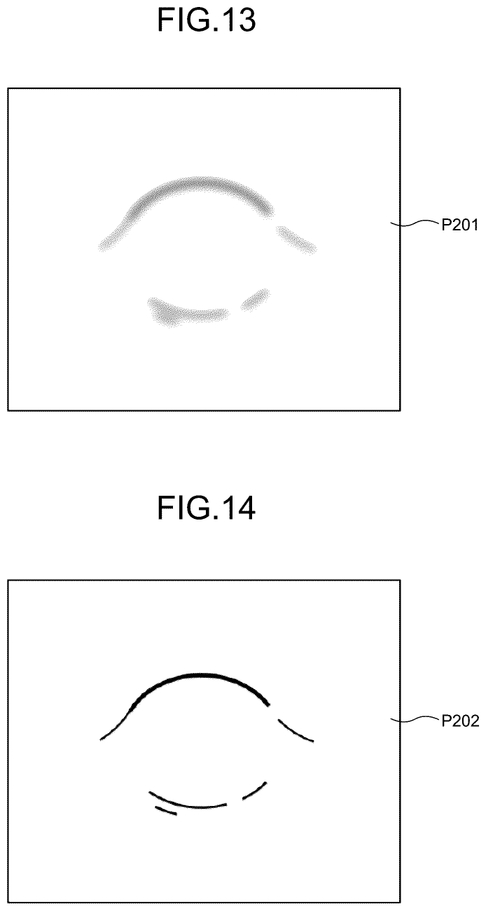

Thereafter, the imaging control unit 410b causes the imaging element 203 to expose and capture the subject image at a predetermined frame rate during the movement period in which the focus lens L5 moves from the near point end to the far point end (Step S306). Specifically, as illustrated in (b) of FIG. 10, during the movement period in which focus lens L5 moves from the near point end to the far point end, the imaging control unit 410b causes the imaging element 203 to expose and capture the subject image at a predetermined frame rate, for example, 60 FPS, thereby generating the plurality of pieces of image data. In this case, as illustrated in FIG. 13, the acquisition unit 410c acquires any one or more of the plurality of pieces of image data generated by the imaging element 203 as a second image P201.

Subsequently, the drive control unit 410a drives the focus adjustment mechanism 206 to stop the focus lens L5 at the far point end (Step S307). Specifically, as illustrated in (a) of FIG. 10, the drive control unit 410a drives the focus adjustment mechanism 206 to stop the focus lens L5 at the far point end.

Thereafter, the imaging control unit 410b causes the imaging element 203 to expose and capture the subject image condensed by the focus lens L5 at the far point end (Step S308). Specifically, as illustrated in FIG. 10 (b), the imaging control unit 410b causes the imaging element 203 to expose and capture the subject image condensed by the focus lens L5 at the far point end. In this case, as illustrated in FIG. 14, the acquisition unit 410c acquires the image data generated by the imaging element 203 as a third image P202.

Subsequently, the drive control unit 410a controls the focus adjustment mechanism 206 to move the focus lens L5 to the position where the AF driving is stopped (Step S309), and starts the AF driving by the focus adjustment mechanism 206 (Step S310).

Thereafter, the inference unit 410d estimates the depth map of the subject using the first image, the second image, and the third image acquired by the acquisition unit 410c and the learned model recorded by the learned model recording unit 408c (Step S311). Specifically, the inference unit 410d inputs the first image, the second image, and the third image acquired by the acquisition unit 410c to the learned model as input parameters, and estimates the depth map of the subject output by the learned model as an output parameter.

Subsequently, the calculation unit 410e estimates the shape of the subject based on the depth map of the subject estimated by the inference unit 410d and the camera parameter of the optical system 202 recorded by the camera parameter recording unit 408d (Step S312).

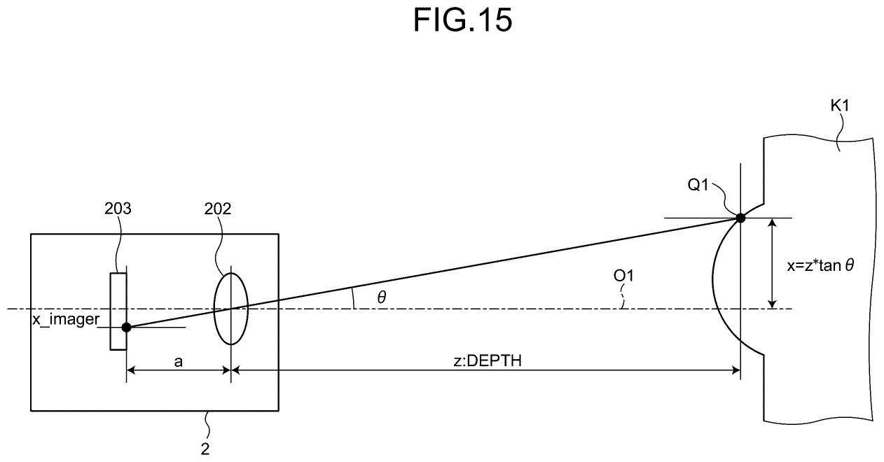

FIG. 15 is a diagram schematically illustrating an estimation method by which the calculation unit 410e estimates the shape of the subject. As illustrated in FIG. 15, in the calculation unit 410e, the following Formula (1) is established where x imager represents a position of a predetermined pixel in the imaging element 203, θ represents an angle at which the optical axis O1 of the optical system 202 intersects a straight line connecting the position Q1 of the predetermined subject and the position x of the imaging element 203, and z represents a distance from the optical system 202 to the position Q1 of the predetermined subject based on the depth map.

x=z×tan θ (1)

The calculation unit 410e estimates the shape of the subject using the above Formula (1) for each pixel of the imaging element 203.

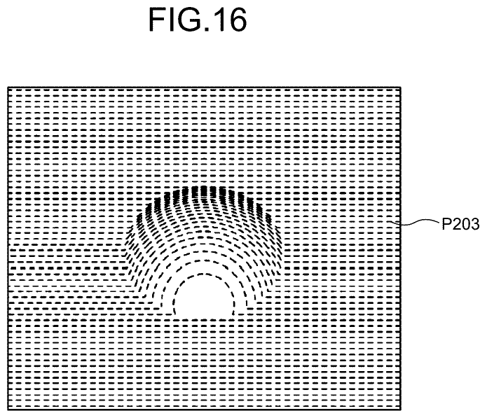

Thereafter, the output control unit 410f outputs the shape of the subject estimated by the calculation unit 410e to the display device 3 (Step S313). Specifically, as illustrated in FIG. 16, the output control unit 410f outputs an image P203 corresponding to the shape of the subject estimated by the calculation unit 410e. After Step S313, the endoscope system 100 returns the process to the main routine of FIG. 8.

According to an embodiment described above, since the inference unit 410d estimates the depth map of the subject using the first image, the second image, and the third image acquired by the acquisition unit 410c and the learned model recorded by the learned model recording unit 408c, it is possible to improve the detection accuracy of the distance from the optical system to the subject as the measurement target.

Furthermore, according to an embodiment, since the calculation unit 410e estimates the shape of the subject based on the depth map of the subject estimated by the inference unit 410d and the camera parameters of the optical system 202 recorded by the camera parameter recording unit 408d, the estimation accuracy of the three-dimensional shape of the subject that is the measurement target can be further improved.

Note that, in an embodiment, the acquisition unit 163 acquires the plurality of second images constituting the video generated by the imaging element 102 during the movement period in which the focus lens L5 moves from the near point end to the far point end. However, the disclosure is not limited thereto, and for example, a focal sweep image may be used instead of a frame constituting the video.

In addition, in an embodiment, the acquisition unit 410c, the inference unit 410d, the calculation unit 410e, and the output control unit 410f are provided in the control device 4, but the disclosure is not limited thereto, and the functions of the inference unit 410d, the calculation unit 410e, and the output control unit 410f may be provided in the image diagnosis device 5. In addition, in an embodiment, in addition to the image diagnosis device 5, the functions of the inference unit 410d, the calculation unit 410e, and the output control unit 410f may be provided in an external server or the like.

### First Modification

Next, the first modification of an embodiment will be described. The first modification has the same configuration as the endoscope system 100 according to the above-described embodiment, and is different in processing to be executed. Specifically, in the above-described embodiment, the imaging element 203 exposes an image to generate the first image and the third image in a state where the focus lens L5 is stopped at the near point end and the far point end, but in the first modification, the imaging element 203 expose an image to generate the first image and the third image at the timing when the focus lens L5 reaches the near point end and the far point end. Therefore, in the following, processing executed by the endoscope system 100 according to the first modification of an embodiment will be described.

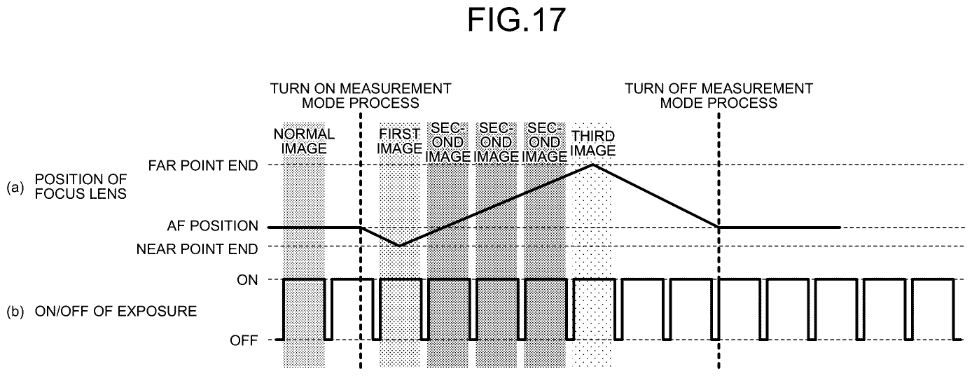

FIG. 17 is a timing chart illustrating the position of the focus lens L5 included in the endoscope 2 on the optical axis O1 and the exposure timing of the imaging element 203 during the measurement mode process. Note that, in FIG. 17, (a) of FIG. 17 illustrates the position of the focus lens L5, and (b) of FIG. 17 illustrates the exposure timing of the imaging element 203.

As illustrated in FIG. 17, the drive control unit 410a drives the focus adjustment mechanism 206 to move the focus lens L5 from the current position to the near point side, and after reaching the near point end, linearly moves the focus lens L5 to the far point side. In this case, the imaging control unit 410b causes the imaging element 203 to expose and capture the subject image condensed by the focus lens L5 at the near point end. At this time, the acquisition unit 410c acquires the image data generated by the imaging element 203 as the first image.

Subsequently, the drive control unit 410a moves the focus lens L5 to the AF stop position after the focus lens L5 arrives at the far point end. In this case, the imaging control unit 410b causes the imaging element 203 to expose and capture the subject image condensed while the focus lens L5 is moving from the near point end to the far point end. At this time, the acquisition unit 410c acquires the image data generated by the imaging element 203 as the second image. Furthermore, the imaging control unit 410b causes the imaging element 203 to expose and capture the subject image condensed by the focus lens L5 at the far point end. At this time, the acquisition unit 410c acquires the image data generated by the imaging element 203 as the third image.

In this manner, the drive control unit 410a linearly moves the focus lens L5 from the near point end toward the far point end. As a result, the time for returning from the measurement mode to the normal mode can be shortened.

According to the first modification described above, since the depth map of the subject is estimated, the detection accuracy of the distance from the optical system to the subject as the measurement target can be improved.

### Second Modification

Next, the second modification of an embodiment will be described. The second modification has the same configuration as the endoscope system 100 according to the above-described embodiment, and is different in processing to be executed. Therefore, in the following, processing executed by the endoscope system 100 according to the first modification of an embodiment will be described.

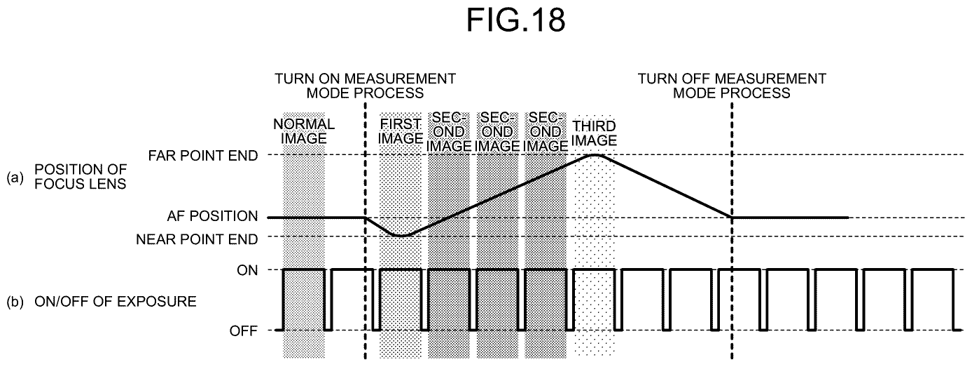

FIG. 18 is a timing chart illustrating the position of the focus lens L5 included in the endoscope 2 on the optical axis O1 and the exposure timing of the imaging element 203 during the measurement mode process. Note that, in FIG. 18, (a) of FIG. 18 illustrates the position of the focus lens L5, and (b) of FIG. 18 illustrates the exposure timing of the imaging element 203.

As illustrated in FIG. 22, the drive control unit 410a drives the focus adjustment mechanism 206 to move the focus lens L5 from the current position to the near point side, to move the focus lens L5 to the near point end so as to stop within a predetermined period of time, to reach the near point end, and then to move the focus lens L5 to the far point side. In this case, the imaging control unit 410b causes the imaging element 203 to expose and capture the subject image condensed by the focus lens L5 at the near point end. At this time, the acquisition unit 410c acquires the image data generated by the imaging element 203 as the first image.

Subsequently, the drive control unit 410a moves the focus lens L5 to the far point end so as to stop within a predetermined period of time, and after arriving at the far point end, moves the focus lens L5 to the AF stop position. In this case, the imaging control unit 410b causes the imaging element 203 to expose and capture the subject image condensed while the focus lens L5 is moving from the near point end to the far point end. At this time, the acquisition unit 410c acquires the image data generated by the imaging element 203 as the second image. Furthermore, the imaging control unit 410b causes the imaging element 203 to expose and capture the subject image condensed by the focus lens L5 at the far point end. At this time, the acquisition unit 410c acquires the image data generated by the imaging element 203 as the third image.

In this manner, the drive control unit 410a smoothly moves the focus lens L5 in a sinusoidal wave from the near point end toward the far point end. As a result, it is possible to obtain the first image and the third image in which blurring due to fine movement of the focus lens L5 is suppressed.

According to the second modification described above, since the depth map of the subject is estimated, the detection accuracy of the distance from the optical system to the subject as the measurement target can be improved.

### Other Embodiments

Various embodiments can be made by appropriately combining a plurality of components disclosed in the endoscope system according to an embodiment of the present disclosure described above. For example, some components may be deleted from all the components described in the endoscope system according to the embodiment of the present disclosure described above. Furthermore, the components described in the endoscope system according to the embodiment of the present disclosure described above may be appropriately combined.

Furthermore, in the endoscope system according to an embodiment of the present disclosure, the above-described “unit” can be replaced with “means”, “circuit”, or the like. For example, the control unit can be read as a control means or a control circuit.

Furthermore, the program to be executed by the endoscope system according to an embodiment of the present disclosure is provided by being recorded in a computer-readable recording medium such as a CD-ROM, a flexible disk (FD), a CD-R, a digital versatile disk (DVD), a USB medium, or a flash memory in file data in an installable format or an executable format.

Furthermore, the program to be executed by the endoscope system according to an embodiment of the present disclosure may be stored on a computer connected to a network such as the Internet and provided by being downloaded via the network.

Note that, in the description of the flowcharts in the present specification, the context of processing between steps is clearly indicated using expressions such as “first”, “thereafter”, and “subsequently”, but the order of processing necessary for implementing the disclosure is not uniquely determined by these expressions. That is, the order of processing in the flowcharts described in the present specification can be changed within a range without inconsistency.

Although some of the embodiments of the present application have been described above in detail with reference to the drawings, these are merely examples, and the disclosure can be implemented in other forms subjected to various modifications and improvements based on the knowledge of those skilled in the art, including the aspects described in the disclosure.

The present disclosure has an effect of further improving estimation accuracy of a three-dimensional shape of a measurement target.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A control device comprising:
one or more processors comprising hardware, the one or more processors being configured to:
acquire first, second and third images from an imaging device;
control the imaging device to generate the first image by an image sensor imaging a subject on a near point side of an optical system,
control the imaging device to generate the second image by the image sensor imaging the subject during a period in which a focal length of the optical system is changed and moved between the near point side and a far point side of the optical system by the focus adjustment mechanism,
control the imaging device to generate the third image by the image sensor imaging the subject on the far point side of the optical system,
input the first, second, and third images to a learned model so as to infer a depth map of the subject indicating a distance from the optical system to the subject, and
output the depth map.

2. The control device according to claim 1, wherein the second image is at least one frame image in a video including an image group which is temporally continuous, the image group being generated by the imaging element during a period in which a focus adjustment mechanism changes the focal length between the near point side and the far point side.

3. The control device according to claim 2, wherein the one or more processors being further configured to:
acquire a camera parameter of the optical system, and
estimate a shape of the subject based on the camera parameter and the depth map of the subject.

4. The control device according to claim 3, wherein the one or more processors being configured to control the focus adjustment mechanism so as to stop the optical system at a near point end and a far point end.

5. The control device according to claim 3, wherein the one or more processors being configured to control the focus adjustment mechanism so as to linearly move the optical system from a near point end to a far point end.

6. The control device according to claim 3, wherein the one or more processors being configured to control the focus adjustment mechanism so as to stop the optical system at each of a near point end and a far point end within a predetermined period of time.

7. An endoscope system comprising:
an endoscope configured to image an inside of a body of a subject; and
the control device according to claim 1 connected to the endoscope,
wherein the endoscope comprises the optical system, the imaging element, and the focus adjustment mechanism.

8. A learned model generator comprising:
one or more processors comprising hardware, the one or more processors being configured to:
acquire learning data obtained by combining a plurality of first images, a plurality of second images, a plurality of third images, and a correct value of a depth map with each of a plurality of targets, from an imaging device,
control the imaging device to generate the plurality of first images by an image sensor imaging the plurality of targets on a near point side of an optical system,
control the imaging device to generate the plurality of second images by the imaging image sensor the plurality of targets during a period in which the focus adjustment mechanism changes and moves a focal length of the optical system between the near point side and a far point side of the optical system,
control the imaging device to generate the plurality of third images by the image sensor imaging the plurality of targets on a far point side of the optical system, the correct value of the depth map being related to a distance from the optical system to each of the plurality of targets, and
generate, by learning using the learning data, a learned model configured to output a depth map indicating a distance from the optical system to a subject as an output parameter with the first, second, and third images as input parameters.

9. The learned model generator according to claim 8, wherein the second image is at least one frame image in a video including an image group which is temporally continuous, the image group being generated by the imaging element during a period in which the focus adjustment mechanism changes the focal length between the near point side and the far point side.

10. The learned model generator according to claim 9, wherein the one or more processors being further configured to:
acquire a camera parameter of the optical system, and
estimate a shape of the subject based on the camera parameter and the depth map of the subject.

11. The learned model generator according to claim 10, wherein the one or more processors being configured to control a focus adjustment mechanism so as to stop the optical system at a near point end and a far point end.

12. The learned model generator according to claim 10, wherein the one or more processors being configured to control the focus adjustment mechanism so as to linearly move the optical system from a near point end to a far point end.

13. The learned model generator according to claim 10, wherein the one or more processors being configured to control the focus adjustment mechanism so as to stop the optical system at each of a near point end and a far point end within a predetermined period of time.

14. A medical assistant method executed by a control device including one or more processors, the medical assistant method comprising:
acquiring, by the processor, first, second and third images from an imaging device
controlling an imaging device to generate the first image by an image sensor imaging a subject on a near point side of the optical system,
controlling the imaging device to generate the second image by the image sensor imaging the subject during a period in which a focal length of the optical system is changed and moved between the near point side and a far point side of the optical system by the focus adjustment mechanism,
controlling the imaging device to generate the third image by the image sensor imaging the subject on the far point side of the optical system;
inputting, by the processor, the first image, the second image, and the third image as input parameters to a learned model configured to output a depth map indicating a distance from the optical system to the subject as an output parameter, to infer a depth map of the subject; and
outputting, by the processor, the depth map of the subject.

15. The medical assistant method according to claim 14, wherein the second image is at least one frame image in a video including an image group which is temporally continuous, the image group being generated by the imaging sensor during a period in which a focus adjustment mechanism changes the focal length between the near point side and the far point side.

16. The medical assistant method according to claim 15, further comprising
acquiring a camera parameter of the optical system, and
estimating a shape of the subject based on the camera parameter and the depth map of the subject.

17. The medical assistant method according to claim 16, further comprising controlling the focus adjustment mechanism so as to stop the optical system at a near point end and a far point end.

18. The medical assistant method according to claim 16, further comprising controlling the focus adjustment mechanism so as to linearly move the optical system from a near point end to a far point end.

19. The medical assistant method according to claim 16, further comprising controlling the focus adjustment mechanism so as to stop the optical system at each of a near point end and a far point end within a predetermined period of time.
